(19) United States
(12) Patent Application Publication
(10) Pub. No.: US 2022/0346396 A1
(43) Pub. Date: Nov. 3, 2022

(54) High-Protein Yogurt Products and Methods

(71) Applicant: Glanbia Nutritionals, Ltd., Kilkenny (IE)

(72) Inventors: Earl Christiansen, Twin Falls, ID (US); Loren S. Ward, Twin Falls, ID (US)

(21) Appl. No.: 17/784,788

(22) PCT Filed: Dec. 11, 2020
(86) PCT No.: PCT/US2020/064697

§ 371 Date: Jun. 13, 2022

Related U.S. Application Data
(60) Provisional application No. 62/946,924, filed on Dec. 11, 2019.
(60) Provisional application No. 63/009,553, filed on Apr. 14, 2020.

(51) Int. Cl. A23C 9/13; A23C 3/02; A23C 9/152; A23C 9/123

(52) U.S. Cl. CPC A23C 9/1307; A23C 3/02; A23C 9/1526; A23C 9/1232

(57) ABSTRACT

Disclosed is a method for making yogurt products of viscosities from about 50 centipoise to about 200,000 centipoise, the yogurt products having a total protein content of at least about 12 percent, the whey protein in the product being primarily in the undenatured state (at least about 75% undenatured). Also disclosed are products made by the method, such as yogurt drinks comprising at least about 12 percent total protein, wherein at least about 75% of the whey protein is in the undenatured state.

### FIELD OF THE INVENTION

The invention relates to methods for producing high-protein yogurt products. More specifically, the invention relates to methods for producing high-protein yogurt products for which the product viscosity can be increased or decreased without the addition of fillers, stabilizers, or other similar ingredients. The invention also relates to methods for producing yogurt products with undenatured whey proteins.

### BACKGROUND OF THE INVENTION

Yogurt is prepared by fermenting milk with bacterial cultures consisting of a mixture of Streptococcus subsp. thermophilus and Lactobacillus delbrueckii subsp. bulgaricus. There are two major types of yogurt—set and stirred. Set yogurt (which describes fruit-on-the bottom products) is formed in pots, resulting in a continuous gel structure. With stirred yogurt, the gel formed during incubation in large fermentation tanks is disrupted by stirring, and the stirred product can then be pumped through a screen to give the product a smooth, but viscous, texture.

The steps involved in yogurt manufacture generally include standardizing the yogurt milk (e.g., by the addition of milk powder, whey protein powder, etc.), homogenizing the yogurt milk (usually in a two-stage homogenization protocol), pasteurizing the yogurt milk, cooling the milk to a temperature that promotes the growth of the bacterial starter culture (generally about 42° C.), adding the starter culture, and incubating (i.e., “culturing”) the yogurt milk with starter culture. When describing the steps of yogurt processing, however, the pasteurization step is often listed as “heat-treating,” rather than pasteurization—because in the industry, the pasteurization step actually serves multiple purposes. First, heat-treatment can be used to kill pathogenic bacteria—and bacteria that might compete with the bacteria in the starter culture. But, heat-treatment also provides a means by which the proteins can be denatured, particularly the whey proteins that, if denatured, crosslink with casein proteins to form the yogurt gel. Since this denaturation takes place at temperatures that are higher than those that are minimally-required to kill bacteria, the industry standard has been to use higher temperatures and temperature/time combinations that are targeted to denature the protein. Temperature/time combinations for the pasteurization step commonly used in the yogurt industry include 85° C. for 30 minutes, or 90-95° C. for 5 minutes. Sometimes, very high temperature short time (100° C. to 130° C. for 4 to 16 seconds) or ultra-heat temperature (UHT) (140° C. for 4 to 16 seconds) are used.

Fermentation of the yogurt milk by the bacterial culture converts lactose into lactic acid, reducing the pH of the milk. This fermentation produces the characteristic yogurt taste. During the acidification, the pH decreases from 6.7 to less than or about pH 4.6, creating a viscoelastic gel. Increased yogurt viscosity is also observed when the total solids content of milk is increased.

The heating step (pasteurization) is important for food safety, but it is also considered to be critical for the formation of the viscoelastic gel, creating a yogurt product from yogurt milk. According to Lee and Lucey (Formation and Physical Properties of Yogurt, Asian-Aust. J. Anim. Sci. (2010) 23(9):1127-1136) native whey proteins from unheated milk are “inert fillers” in yogurt. It takes the heating step to make the proteins useful for the formation of the yogurt gel. When milk is heated at greater than 70° C., the major whey proteins, such as β-lactoglobulin, are denatured, the β-lactoglobulin interacts with K-casein by disulfide bridging, resulting in increased gel firmness and viscosity of yogurt. They disclose that denatured whey proteins attaching to the surface of casein micelles are critical to the increased stiffness of yogurt gels made from heated milk.

“Whey protein” is a general term describing the proteins found in the aqueous fraction of milk that is removed during cheese making. Proteins, peptides and enzymes found in whey include β-lactoglobulin, α-lactalbumin, glycomacropeptide (GMP), bovine serum albumin (BSA), immunoglobulins, lactoferrin and lactoperoxidase. Denaturation of whey proteins is also considered to be important for increasing stiffness, firmness, viscosity and water holding capacity of yogurt gels (Pakseresht, S., et al. Optimization of low-fat set-type yoghurt: effect of altered whey protein to casein ratio, fat content and microbial transglutaminase on rheological and sensorial properties, J Food Sci Technol. (2017) 54(8): 2351-2360). Native (undenatured) whey proteins, however, provide some nutritional benefits that are better than those of denatured whey proteins. For example, 20 g of native whey induced a significantly faster increase and higher peak values in blood leucine concentrations than 20 g of MWP, WPH, WPC-80 and milk after a bout of strength training (Hamarsland, H., Native whey induces higher and faster leucinemia than other whey protein supplements and milk: a randomized controlled trial, BMC Nutrition (2017) 3:10). Based on studies in mice, native whey has also been proposed to promote an improved immune response and higher glutathione levels than does denatured whey (Bounous, G. et al. The Biological Activity of Undenatured Dietary Whey Proteins: Role of Glutathione, Clin. Invest. Med. (1991) 14: 296-309.

Yogurt is a staple food in many countries. It is a source of protein, calcium, phosphorus, B vitamins (Riboflavin and B12), tryptophan, vitamin C, folate, and zinc. It could provide even more benefit if the whey protein could be in the native state to preserve the functionality and bioactivity of the proteins.

### SUMMARY OF THE INVENTION

The invention relates to a method for producing at least one high-protein yogurt product, the method comprising the steps of preparing a yogurt milk for culture by adding to the milk at least one protein-containing component selected from the group consisting of at least one casein-containing component, at least one whey protein-containing component, and combinations thereof, to give a whey/casein ratio of from about 20:80 to about 90:10 in the yogurt milk; heat-treating the yogurt milk under pasteurization conditions that maintain at least about 75 percent of the whey protein in its undenatured state; and culturing the yogurt milk with at least one bacterial culture to produce a yogurt product, wherein the addition of the at least one protein-containing component results in a total protein content in the yogurt of at least about 12 percent, and the amount and ratio of the protein-containing component that is added to the yogurt milk is adjusted to modulate the viscosity of the yogurt product in a range from thin to thick. In various aspects, the protein-containing component is selected from the group consisting of milk, cream, skim milk, WPC, WPI, MPC, MPI, non-fat dry milk (NFDM), UF milk, and combinations thereof.

In various aspects, the method comprises combining at least one protein-containing component selected from the group consisting of at least one casein-containing component, at least one whey protein-containing component, and combinations thereof, to produce a yogurt milk with a whey/casein ratio of from about 20:80 to about 90:10 in the yogurt milk; heat-treating the yogurt milk under pasteurization conditions that maintain at least about 75 percent of the whey protein in its undenatured state; and culturing the yogurt milk with at least one bacterial culture to produce a yogurt product, wherein the addition of the at least one protein-containing component results in a total protein content in the yogurt of at least about 12 percent, and the amount and ratio of the protein-containing component that is added to the yogurt milk is adjusted to modulate the viscosity of the yogurt product in a range from thin to thick.

In various embodiments of the method, the viscosity of the product produced by the method can comprise from about 100 cP to about 200,000 cP. In various embodiments, the addition of the at least one protein-containing component results in a total protein content in the yogurt of at least about 12 percent. In various aspects of the invention, the total protein content in the yogurt is from about 12 to about 25 percent.

The invention also provides a yogurt product comprising from about 12 to about 25 percent protein, the yogurt product comprising both casein and whey protein, wherein at least about 75 percent of the whey protein is in the undenatured state.

### BRIEF DESCRIPTION OF THE DRAWINGS

FIG. 1 is a photo of a liquid yogurt product made by the method of the invention, using 80% whole milk and 20% wpi (20% protein), heat-treated (pasteurized) at 166° F. for 15 seconds, homogenized at 2500 psi, 1150 cP.

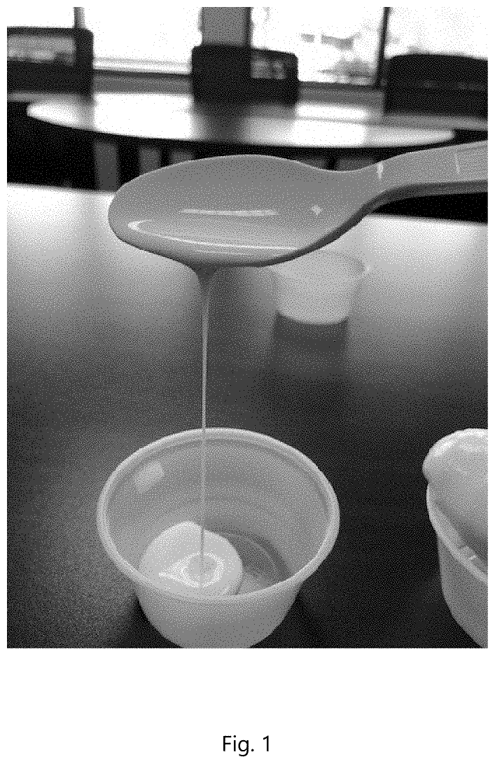

FIG. 2 is a photo of a thick (full-bodied) yogurt product made by the method of the invention, using 80% whole milk, 10% MPI, and 10% WPI (20% protein), heat-treated at 166° F. for 15 seconds, homogenized at 2500 psi, 30000 cP.

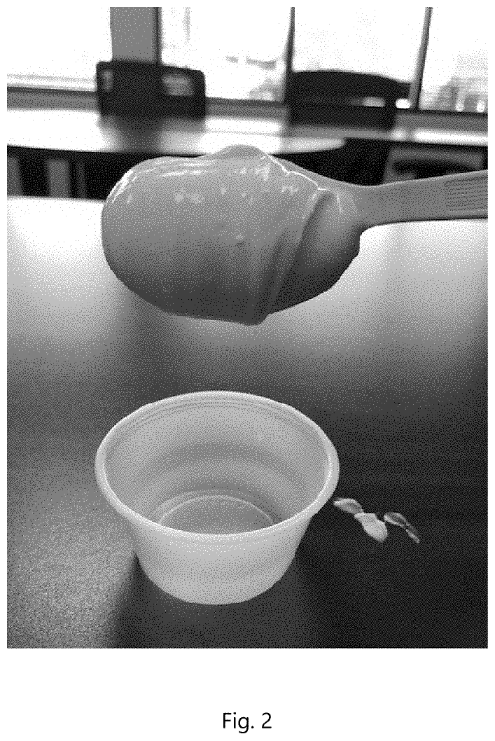

### DETAILED DESCRIPTION

Disclosed is a method for manufacturing yogurt, wherein mild pasteurization conditions and casein-to-whey ratio adjustment are combined to produce yogurt products having viscosities that can be targeted within a range of from about 50 cP to about 200,000 cP. Lower-viscosity products can comprise liquid yogurt products (e.g., beverage yogurts), yogurt syrups, and other flowable products. Higher-viscosity products can comprise products with the consistency of peanut butter, for example, which can be spreadable, cling to a spoon or stick, etc. The ratio of whey to casein ranges from about 20:80 to about 90:10, with higher casein/whey ratios shifting the viscosity toward thicker products and lower casein/whey ratios (higher whey/casein ratios) shifting the viscosity toward that of thinner, more flowable products. Examples of the effect of the casein/whey ratio on yogurt product viscosity are shown below in Table 1.

TABLE 1
Effect of Casein/Whey Ratio on Yogurt Product Viscosity

| | | Approximate |
|---|---|---|
| Product Viscosity | % Casein vs. Whey | Casein/Whey Ratio |
| Thin (Liquid) | 19%/81% | 1:4 |
| Spoonable | 32%/68% | 1:2 |
| Thick | 52%/48% | 1:1 |

A yogurt product produced by the method should comprise whey protein wherein at least about 75 percent of the whey protein is undenatured (native). In many aspects of the invention, native undenatured whey can comprise at least about 90% native whey protein.

The method of the invention encompasses the use of milk which can be derived from various mammalian sources, but in the industry is usually of bovine origin. It will be understood by those of skill in the art that milk can be in the form of whole milk, skim milk, reduced fat milk, etc., that it may be concentrated and reconstituted sufficiently for yogurt culture by the addition of water, and that it may be produced by admixing milk powder with water to sufficiently reconstitute the powder to produce a starting material for yogurt culture. Therefore, the method also comprises combining at least one protein-containing component selected from the group consisting of at least one casein-containing component, at least one whey protein-containing component, and combinations thereof, to produce a yogurt milk with a whey/casein ratio of from about 20:80 to about 90:10 in the yogurt milk; heat-treating the yogurt milk under pasteurization conditions that maintain at least about 75 percent of the whey protein in its undenatured state; and culturing the yogurt milk with at least one bacterial culture to produce a yogurt product, wherein the addition of the at least one protein-containing component results in a total protein content in the yogurt of at least about 12 percent, and the amount and ratio of the protein-containing component that is added to the yogurt milk is adjusted to modulate the viscosity of the yogurt product in a range from thin to thick.

Unless stated otherwise, amounts (particularly those of whey and casein) are given on an as-is basis (e.g., as grams per 100 g finished product). The term “yogurt product,” as used herein, is a fermented milk product made by the method of the invention. Yogurt products made by the method of the invention can be of viscosities ranging from about 50 cP to about 200,000 cP. Because they are yogurts, they may also be referred to as such herein. “Yogurt” is defined by the United States Food and Drug Administration, for example, as a product that is produced by culturing dairy ingredients using lactic acid-producing bacteria. Dairy ingredients for yogurt production comprise cream, milk, partially skimmed milk, skim milk, and combinations thereof. Other optional ingredients include, for example, concentrated skim milk, nonfat dry milk, buttermilk, whey, lactose, lactalbumins, and lactoglobulins. Products made by the method of the invention meet this definition, while providing a range of products—from liquid yogurts to spreadable, thick products—that provide excellent options for consumers. “Native protein(s)” and “undenatured protein(s)” are used interchangeably herein, both referring to proteins that are fully functional, being unaltered by denaturation due to the heat used in pasteurization/heat treatment.

The method of the invention produces high-protein yogurt products, the method comprising the steps of preparing a yogurt milk by adding to milk at least one protein-containing component selected from the group consisting of at least one casein-containing component, at least one whey protein-containing component, and combinations thereof, to give a whey/casein ratio of from about 20:80 to about 90:10 in the yogurt milk; heat-treating the yogurt milk at a pasteurization temperature that retains at least about 75 percent of the whey protein in its undenatured state; and culturing the yogurt milk with at least one bacterial culture to produce a yogurt product, wherein the addition of the at least one protein-containing component results in a total protein content in the yogurt of at least about 12 percent (e.g., from about 12 percent to about 25 percent) and the amount and ratio of the protein-containing component that is added to the yogurt milk is adjusted to modulate the viscosity of the yogurt product from about 50 cP to about 200,000 cP.

By way of illustration, a syrup such as corn syrup typically has a viscosity of 50-100 cP, and peanut butter typically has a viscosity in the range of from about 150,000 cP to about 200,000 cP. The viscosity of commercial Greek yogurt is generally about 21,000 cP. Viscosity is given herein as centipoise, which is abbreviated herein as either cP or cps. Therefore, the method provides a manufacturer with the option of producing liquid yogurt products, yogurt products having a standard viscosity, yogurt products with a viscosity similar to that of Greek yogurt, and yogurt products having a viscosity similar to that of thick peanut butter, for example.

Standard methods for producing yogurt are known to those of skill in the art, and these methods can be used to make products according to the method of the invention, utilizing pasteurization temperatures that are mild enough to generally maintain whey protein in its native state and ingredients that provide a higher casein-to-whey ratio for more viscous yogurt products (e.g., spreadable yogurt product) or a higher whey-to-casein ratio for liquid yogurt products, for example.

Materials for yogurt production can be selected from raw or pasteurized milk, separated raw or pasteurized cream, raw or pasteurized skim milk, nonfat dry milk (NFDM), whey protein concentrate (WPC), whey protein isolate (WPI), milk protein concentrate (MPC), liquid UF milk retentate (“UF milk,” milk filtered to produce a lower lactose, higher protein product than standard milk), and milk protein isolate (MPI), for example. In various aspects, the protein-containing component is selected from the group consisting of milk, cream, skim milk, WPC, WPI, MPC, MPI, non-fat dry milk (NFDM), and combinations thereof. Various combinations of these ingredients are used to produce products having viscosities within the range of from about 50 centipoise (cP) to about 200000 centipoise (cP). For example, as shown below in Table 2, varying the amounts of WPI and MPC added to the yogurt milk can produce products having different levels of protein, as well as different viscosities, while the yogurt products maintain high levels of undenatured whey protein in the whey protein fraction of the products.

TABLE 2
Protein Sources and Amounts - Yogurt Products

| | | Liquid | Medium Body | Heavy Body |
|---|---|---|---|---|
| 11% Protein | Milk | 90% | 90% | 90% |
| | WPI | 8.25% | 5% | 3.75% |
| | MPC | 1.75% | 5% | 6.25% |
| 17% Protein | Milk | 83% | 83% | 83% |
| | WPI | 14.5% | 8.5% | 6.75% |
| | MPC | 1.5% | 8.5% | 10.25% |
| 25% Protein | Milk | 74% | 73.3% | 73% |
| | WPI | 25% | 13.25% | 10.75% |
| | MPC | 1% | 13.25% | 16.25% |

To make yogurt products, ingredients selected to provide a source of casein protein, whey protein, or various combinations thereof, can be combined with yogurt milk and processed under pasteurization conditions that promote the maintenance of the whey proteins in their native state. Pasteurization conditions can include minimum pasteurization temperatures for appropriate holding times, flash pasteurization (high temperature, short time, 166° F. for 15 seconds), batch pasteurization (150° F. for 30 minutes), or higher heat shorter time (HHST, 194° F. for 0.5 seconds), for example. Yogurt milk and the added ingredients are homogenized and cooled to fermentation temperatures of 95-112° F. (about 42° C.). Bacterial starter culture is added, and the mixture is fermented to a final pH of 4.3 to 4.75, then stirred, sheared and cooled to 35-50° F. At this point, flavor can be added, the yogurt can be mixed with fruit, etc., and it can be dispensed into appropriate containers for storage, shipping, and sale.

Whey protein is commonly provided as whey protein isolate (WPI) or whey protein concentrate (WPC). Milk protein isolate (MPI) contains whey protein, but the whey protein composition is only a fraction of the total protein content—the primary protein component in milk being casein. Whey protein concentrates and isolates can be produced by various means, which generally involve separation technologies such as, for example, filtration methods. Preferred whey protein compositions comprise whey protein isolates that provide the major whey proteins comprising beta-lactoglobulin, alpha-lactalbumin, glycomacropeptide (GMP), immunoglobulins, bovine serum albumin (BSA), and lactoferrin. Maintaining the whey proteins in the native (undenatured) state provides protein functionality in the resulting yogurt product that enhances its nutritional value. Beta-lactoglobulin, for example, is rich in cysteine, an important amino acid in the synthesis of glutathione. Alpha-lactalbumin is an important source of bioactive peptides and essential amino acids, including tryptophan, lysine, branched-chain amino acids, and sulfur-containing amino acids. Glycomacropeptide (GMP) is a C-terminal part (106-169) of kappa-casein that is released into whey during cheese making. Glycomacropeptide may help control and inhibit the formation of dental plaque and dental caries, promotes satiety, and has been reported to have antimicrobial, anticariogenic, gastric acid inhibitory, cholecystokinin-releasing, prebiotic, and immune modulatory benefits. Bovine serum albumin has fatty-acid binding, antimutagenic, and cancer prevention effects. Lactoferrin can be beneficial for treatment of stomach and intestinal ulcers, diarrhea, and hepatitis C infection. It has antioxidant activity and protects against bacterial and viral infections. It is an immune modulator, prevents tissue damage related to aging, promotes healthy intestinal bacteria, may prevent some forms of cancer, and regulates the way the body processes iron. Table 3 lists the major protein fractions, and their relative percentages, in a commercially-available whey protein isolate used by the inventor in the method of the invention.

TABLE 3
Protein Composition of a Commercially-
Available Whey Protein Isolate*

| | |
|---|---|
| Beta-Lactoglobulin | 52.9% |
| Alpha-Lactalbumin | 22.4% |
| Glycomacropeptide | 21.0% |
| Immunoglobulins | 1.8% |
| Bovine Serum Albumin | 1.4% |
| Lactoferrin | 0.5% |

*Provon ®, Glanbia Nutritionals, Inc., Monroe, Wisconsin

Minimum pasteurization conditions are known to those of skill in the art of dairy food production. These conditions are generally the minimum processing conditions needed to kill Coxiella burnetii, the organism that causes Q fever in humans. C. burnetii is the most heat-resistant pathogen currently recognized in milk. In the United States, for example, the Pasteurized Milk Ordinance (PMO) mandates the conditions which must be met in order to achieve minimum pasteurization conditions. Interestingly, however, pasteurization can be achieved with minimal levels of denaturation of the important proteins that can be found in milk-5 percent or less of the whey protein, for example—although because of the general consensus that denaturation of whey protein (especially beta-lactoglobulin) is necessary for yogurt processing and the formation of yogurt gels, it has been customary in the industry to use pasteurization conditions that are designed to result in protein denaturation, although they are not required by the PMO. The inventor has discovered that yogurt products of desirable gel strength and viscosity can be produced without denaturing the whey protein, and in fact, that by utilizing pasteurization conditions that maintain the undenatured state of the proteins, it is possible to produce products of varying viscosities that can be targeted specifically by a dairy processor by adjusting the amounts of proteins that can be added to the yogurt milk, and even more importantly, by adjusting the ratio of the casein proteins to the whey proteins. Table 4 lists temperature and time combinations that are considered sufficient to destroy C. burnetii and meet the legal standard for pasteurization. These temperature/time combinations can be used in the method of the invention to achieve pasteurization while maintaining at least about 75 percent of the whey protein in its undenatured state. Generally, these combinations can produce the desired pasteurization effect while producing minimal denaturation (e.g., less than 10% denaturation of the whey proteins).

TABLE 4
Temperature and Time Combinations
for Milk Product Pasteurization

| Temperature | Time | | Pasteurization Type |
|---|---|---|---|
| 63° C. (145° F.) | 30 | minutes | Vat Pasteurization |
| 72° C. (161° F.) | 15 | seconds | High temperature short time |
| | | | Pasteurization (HTST) |
| 89° C. (191° F.) | 1.0 | second | Higher-Heat Shorter Time (HHST) |
| 90° C. (194° F.) | 0.5 | seconds | Higher-Heat Shorter Time (HHST) |
| 94° C. (201° F.) | 0.1 | seconds | Higher-Heat Shorter Time (HHST) |
| 96° C. (204° F.) | 0.05 | seconds | Higher-Heat Shorter Time (HHST) |
| 100° C. (212° F.) | 0.01 | seconds | Higher-Heat Shorter Time (HHST) |
| 138° C. (280° F.) | 2.0 | seconds | Ultra-Pasteurization (UP) |

If the milk product is concentrated (condensed), the temperature is increased by 3° C. (5° F.). Source: International Dairy Foods Association (IDFA), https://www.idfa.org/news-views/media-kits/milk/pasteurization.

Others have previously described yogurt products having a percentage of undenatured whey protein (EP3042565A1, Jorgensen et al.) However, Jorgensen et al. use separation technology to isolate the components of the yogurt milk and then remix them. More importantly, they teach heating the mixture of casein and native whey protein at a temperature and for a time period sufficient to obtain denaturation of 30 to 70% of the native whey protein of the mixture. The present invention does not require such separation of the components of the yogurt milk, and the inventor has discovered that yogurt products of desirable viscosity can readily be made without denaturing 30 to 70 percent of the whey protein. In fact, the inventor has made several products—from liquid yogurts to spreadable yogurts—that have no detectable denatured protein in them. The method of the present invention therefore provides that at least about 75% of the whey proteins are in their native—and therefore functional—state.

Pasteurization conditions for specific products can be readily determined by those of skill in the art. Minimum legal requirements are well-known, and the kinetics of denaturation of beta-lactoglobulin has been previously reported (Sava, N. et al. The Kinetics of Heat-Induced Structural Changes of β-Lactoglobulin, J. Dairy Sci. (2005) 88:1646-1653).

The invention provides liquid yogurt products which are actual liquid fermented yogurts, rather than the standard commercial yogurt-flavored beverages produced by using standard yogurt or Greek yogurt as an ingredient that is added into liquid to give a beverage with a yogurt flavor. In commercially-available yogurt-flavored beverages, which are often referred to as “yogurt drinks,” the yogurt ingredients are generally produced by conventional methods that include high-temperature pasteurization, so the proteins in the resulting yogurt drink (which may in reality be only flavored with yogurt) are in their denatured state.

Yogurt products made by the method of the invention may also contain colorings, flavorings, and other ingredients as desired by the manufacturer of the yogurt product. However, they can also be as “clean label” as having milk, whey protein, and casein as ingredients—all-natural ingredients.

Yogurt products of the invention can include yogurt beverages, yogurt syrups, standard yogurts, Greek yogurts, yogurt pastes, spreadable yogurt products, yogurt in a sleeve or tube that can be eaten by squeezing the tube or by means of a packaging similar to that of an ice cream treat such as what is known as push-pop (sold under brand names such as PushUp®, PopUp®, and Push-Em®). Yogurt products made by the method of the invention can also include yogurt powders (i.e., powdered yogurt), which are made by drying yogurt made by the method of the invention to produce a high-protein yogurt powder. Suitable drying conditions, such as for spray-drying, are known to those of skill in the art. Spray-drying can, for example, be performed using an inlet temperature of from about 235 to about 245 degrees Celsius and outlet temperature of from about 90 to about 95 degrees Celsius.

One additional advantage provided by the invention that should be pointed out is that the method allows for the production of high-protein yogurt products having protein levels higher than that of conventional commercially-available yogurt products. Table 5 lists the protein content of a variety of commercially-available yogurt products. It is not surprising that the higher protein content products are the Greek yogurts, so the list below includes only Greek yogurt products.

TABLE 5
Protein Content - Commercially-Available Greek Yogurt

| | | AMOUNT OF | |
|---|---|---|---|
| | SERVING | PROTEIN | % |
| BRAND NAME | SIZE (GMS) | (GMS) | PROTEIN |
| Chobani ® | 170 | 16 | 9.4% |
| Yoplait ® | 170 | 16 | 9.4% |
| Fage ® | 170 | 17 | 10.0% |
| Activia ® | 170 | 16 | 9.4% |
| Stonyfield ® | 227 | 21 | 9.3% |
| Oikos ® | 170 | 13 | 7.6% |
| Two Good ® | 170 | 14 | 8.2% |
| Nounos ® | 150 | 15 | 10.0% |
| Great Value ® | 170 | 17 | 10.0% |
| Member's Mark ® | 170 | 18 | 10.6% |
| Kroger ® | 150 | 15 | 10.0% |
| Simple Truth ® | 170 | 15 | 8.8% |
| Odyssey ® | 150 | 13 | 8.7% |
| Kirkland ® | 170 | 16 | 9.4% |
| Trader Joe's ® | 227 | 22 | 9.7% |
| Friendly Farms ® | 170 | 16 | 9.4% |

As shown above, even in the higher-protein Greek yogurts protein levels generally do not reach 11%. The method of the invention provides yogurt products of viscosities that can be varied as desired, while also providing yogurt products having total protein content (i.e., including both the casein and whey protein fractions) that can be at least about 12 percent. In various embodiments, total protein content can comprise from about 12 to about 25 percent, for example.

Where the term “comprising” is used herein, it should be understood that the terms “consisting of” and “consisting essentially of” can also be used to describe and claim the invention in a more narrow construction.

The invention will now be described by means of the following non-limiting examples.

### Examples

### Production of Shelf-stable Ambient Storage Yogurt

Whole milk, whey protein isolate (WPI), and milk protein isolate (MPI) were mixed (88% whole milk, 11% WPI, 1% MPI) to give a yogurt milk composition comprising 15% protein. Protein was hydrated for 20 minutes at 90 degrees Fahrenheit for 30 minutes, then pasteurization was performed at 167° F. for 20 seconds. The pasteurized product was homogenized at 2500 psi, cooled to 108° F. (about 42° C.), and inoculated with commercial yogurt culture. The inoculated mixture was incubated (cultured) at 108° F. until the pH reached 4.65 (5 hours), and the set yogurt was broken with agitation. The yogurt product was pasteurized at 166° F. for 6 seconds, aseptically mixed with flavor, and filled into aseptic containers.

### Producing Drinkable, Spoonable, and Extra Thick Yogurt Products

Amounts of ingredients in yogurt milk are listed below in Table 6 for products characterized as “thin,” “spoonable,” or “extra thick.” Ingredients were mixed, and heated using APV HTST, 16 second hold. Homogenization was performed using GIA (2000-2500 psi). The homogenized product was inoculated with bacterial culture (Chr Hansen xc-11).

TABLE 6

| | | | |
|---|---|---|---|
| Thin | 1% MPI | 13% WPI | 86% whole milk |
| Spoonable | 6% MPI | 13% WPI | 81% whole milk |
| Extra Thick | 9% MPI | 6% WPI | 85% skim milk |

WPI—Optisol 1092 (Glanbia Nutritionals, Inc., Monroe, WI)
MPI—MPI 90 (Idaho Milk Products, Jerome, ID)

High-Protein Yogurt from Milk/Protein Powders

Yogurts were also produced by combining powder with water to provide the starting material. Two separate products were made. The first combined 83% water with 8% non-fat dry milk powder, 8% whey protein isolate, and 1% milk protein concentrate. The second combined 79% water with 9% whole milk powder, 8% milk protein concentrate, and 4% whey protein concentrate. These yogurt products were generally indistinguishable from those made using liquid milk as the starting material.

What is claimed is:

1. A method for producing at least one high-protein yogurt product, the method comprising the steps of
(a) preparing a yogurt milk by adding to the milk at least one protein-containing component selected from the group consisting of at least one casein-containing component, at least one whey protein-containing component, and combinations thereof, to give a whey:casein ratio of from about 20:80 to about 90:10 in the yogurt milk;
(b) heat-treating the yogurt milk under pasteurization conditions that maintain at least about 75 percent of the whey protein in its undenatured state; and
(c) culturing the yogurt milk with at least one bacterial culture to produce a yogurt product,
wherein the addition of the at least one protein-containing component results in a total protein content in the yogurt of at least about 12 percent, and the amount and ratio of the protein-containing component that is added to the yogurt milk is adjusted to modulate the viscosity of the yogurt product from about 50 centipoise to about 200,000 centipoise.

2. The method of claim 1 wherein the protein-containing component is selected from the group consisting of milk, cream, skim milk, WPC, WPI, MPC, MPI, non-fat dry milk (NFDM), UF milk, and combinations thereof.

3. The method of claim 1 wherein the total protein content comprises at least about 12 percent.

5. The method of claim 1 wherein the total protein content comprises from about 12 percent to about 25 percent.

6. The method of claim 1 wherein at least about 95 percent of the whey protein is in the undenatured state.

7. A yogurt product comprising at least about 12 percent protein, the protein comprising both casein and whey protein, wherein at least about 75 percent of the whey protein is in the undenatured state.

8. The yogurt product of claim 7 wherein the protein comprises at least about 15 percent.

9. The yogurt product of claim 7 wherein at least about 95 percent of the whey protein is in the undenatured state.

10. A yogurt drink comprising at least about 12 percent protein, the protein comprising casein and whey proteins at a ratio of about 1:4, wherein at least about 75 percent of the whey protein is in the undenatured state.

11. A method for making high-protein powdered yogurt, the method comprising the steps of comprising the steps of
(a) preparing a yogurt milk by adding to the milk at least one protein-containing component selected from the group consisting of at least one casein-containing component, at least one whey protein-containing component, and combinations thereof, to give a whey:casein ratio of from about 20:80 to about 90:10 in the yogurt milk, the addition of the at least one protein-containing component producing a total protein content in the yogurt of at least about 12 percent, and the amount and ratio of the protein-containing component that is added to the yogurt milk adjusting the the viscosity of the yogurt product from about 50 centipoise to about 200,000 centipoise;
(b) heat-treating the yogurt milk under pasteurization conditions that maintain at least about 75 percent of the whey protein in its undenatured state;
(c) culturing the yogurt milk with at least one bacterial culture to produce a yogurt product; and
(d) drying the yogurt product to produce a powdered yogurt.

12. A high-protein yogurt powder comprising casein and whey proteins, the powder comprising at least about 12 percent protein, wherein at least about 75% of the whey protein is present as undenatured whey protein.
